(19) United States
(12) Patent Application Publication
(10) Pub. No.: US 2006/0245533 A1
(43) Pub. Date: Nov. 2, 2006

(54) Virtualizing UART interfaces

(76) Inventor: Arad Rostampour, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/116,556

(22) Filed: Apr. 28, 2005

(51) Int. Cl. H04L 23/00

(52) U.S. Cl. 375/377

(57) ABSTRACT

Communicating external data with one or more operating systems of a data processing arrangement involves virtualizing one or more Universal Asynchronous Receiver-Transmitter (UART) interfaces via a component of the data processing arrangement that operates outside the control of the operating systems. Each of the UART interfaces is associated with at least one operating system of the one or more operating systems. The data is communicated between the UART interfaces and the associated operating systems via calls to standardized software of the associated operating systems. The data is then communicated between the UART interfaces and a non-UART device of the data processing arrangement.

### FIELD OF THE INVENTION

The present disclosure relates to data processing, and in particular to virtualizing device interfaces.

### BACKGROUND

Modern personal computers (PC) have benefited from many technological innovations over the past decades. Performance gains have been achieved by increasing processor speed, as well as increasing data transfer speed over input-output (I/O) busses. The progress in I/O speeds has largely come about through the implementation of new interface standards, although backwards compatibility has required that many legacy interfaces still be included on PCs.

In the x86 processor world, the original standard I/O interfaces included serial and parallel ports for external peripherals, the Industry Standard Architecture (ISA) bus for plug-in cards, and the Integrated Drive Electronics (IDE) interface for floppy disk and hard drives. Modern PCs may still contain some of these interfaces, but there has been a steady transition to Universal Serial Bus (USB) and IEEE 1394 for external peripherals, Peripheral Component Interconnect (PCI) bus for cards, and Enhanced IDE and AT Attachment (ATA) hard drives. Other specialized interfaces have been developed for various hardware and environments, such as Personal Computer Memory Card International Association (PCMCIA) devices for portable computers and Advanced Graphic Processor (AGP) bus interfaces for video cards.

With all of the advances in computer I/O standards, the operating system may still need access to a well-known, generic interface. These generic interfaces represent a lowest common denominator that can safely be used under a number of circumstances. For example, many operating system kernels read from and write to bi-directional kernel ports. Access to these ports may be provided by a console device. Historically, these console devices were “dumb” terminals that connected to a serial port of the computer. In such systems, certain critical data such as kernel debugging output was directed to this terminal.

A dumb terminal is usually connected to a Universal Asynchronous Receiver-Transmitter (UART) of the host machine. The UART sends and receives data over serial transmission lines. The UART serializes outgoing data and assembles incoming serial data into bytes and places those bytes in a buffer. Although many commonly used UARTs communicate asynchronously on the transmission lines, similar devices exist that communicate synchronously, e.g. where both communicating devices are synched to a clock signal.

Kernel logs and other low level components utilize UARTs because they are simple, reliable, and widely supported. The UART software used by the kernel is well-tested, and is the most likely to remain operational during system failures, such as when the kernel is in a panic state. Although lowest common denominator video and keyboard interfaces exist, in some systems (e.g., servers) it is not desirable to hook up a monitor and keyboard. In large data centers, for example, it is not always practical to include wiring and switching needed to access a kernel console for each of hundreds of machines.

In many cases, using a terminal connected to a UART is still the best way to access the kernel. However, many computer systems can have multiple instances of an operating system running on the same machine. Each instance of the operating system should have exclusive control over at least one UART in order to access the kernel. Although this may be implemented by providing a UART device for each partition, such a solution increases costs, space required, and power consumption. In many densely packed data centers, all three of these factors are at a premium. Therefore, it is desirable to provide multiple UART interfaces on a computer without increasing hardware size, cost, and power consumption.

### SUMMARY

Communicating data with one or more operating systems of a data processing arrangement involves virtualizing one or more Universal Asynchronous Receiver-Transmitter (UART) interfaces via a component of the data processing arrangement that operates outside the control of the operating systems. Each of the UART interfaces is associated with at least one operating system of the one or more operating systems. The data is communicated between the UART interfaces and the associated operating systems via calls to standardized software of the associated operating systems. The data is then communicated between the UART interfaces and a non-UART device of the data processing arrangement.

### BRIEF DESCRIPTION OF THE DRAWINGS

FIG. 1 illustrates a software architecture configured for providing virtual UART access according to embodiments of the present invention;

FIG. 2 illustrates a system arranged to utilize virtual UART access according to embodiments of the present invention;

FIG. 3 illustrates a computing arrangement configured for providing virtual UART access according to embodiments of the present invention;

FIG. 4 illustrates a partitionable computing arrangement configured for providing virtual UART access according to embodiments of the present invention; and

FIG. 5 illustrates a procedure for providing virtual UART access according to embodiments of the present invention.

### DETAILED DESCRIPTION

In the following description of various embodiments, reference is made to the accompanying drawings that form a part hereof, and in which is shown by way of illustration various example manners by which the invention may be practiced. It is to be understood that other embodiments may be utilized, as structural and operational changes may be made without departing from the scope of the present invention.

In general, the present disclosure relates to virtualizing and/or a UART in system firmware and/or hardware. The virtual UART can be used to send data via another data transfer device, such as via a network card, Universal Serial Bus (USB) adaptor, IEEE1394 (Firewire), wireless interface, etc. Using a high bandwidth data transfer device allows combining a large number of low-data-rate terminal outputs into a single connection. Advantages of virtualizing/emulating a UART in this manner may include backwards compatibility for critical software components, lower cost, and providing remote access using a minimum of wiring.

It will be appreciated that many computing systems can benefit by utilizing an virtual UART in accordance with embodiments of the invention. In particular, systems that require a plurality of serial interfaces on a single device may benefit from this approach. One type of system that may benefit from multiple serial interfaces includes partitionable systems. A partitionable system consists of nodes (or cells) where the partitions are subsystems allocated to independent jobs. Each partition in such a system runs a fault-contained instance of a potentially different operating system. There may be at least one debug port per active partition.

In a partitioned system, it may become difficult to assign ports depending on firmware and OS settings. Additionally, keeping track of the wiring to multiple serial ports of a partitioned system can become cumbersome. This is especially true when partitions can be manually or automatically reassigned or reconfigured. Nonetheless, there are many advantages to providing UART interfaces to partitioned systems and similar computing arrangements. These advantages include compatibility and reliability. Also, the OS can utilize an existing legacy driver to access the UART, thereby precluding the need for special device drivers.

Instead of using multiple hardware UARTs, a computing arrangement may use an interface that emulates a plurality of UARTs using virtual UART interfaces. The term virtual, as used in the field of computer science, is commonly applied to things that are simulated by the computer. For example, virtual memory is memory that is not provided by memory chips, but by other data storage such as hard drives. The term “virtual” may be used to describe things that mimic their “real” equivalents. As used herein, the term “virtual” as applied to UARTs and UART interfaces generally refers to providing UART access and UART functionality without employing traditional UART circuitry. A virtual UART interface emulates the processor interface logic provided by UART circuitry, but does not require emulation of other UART interfaces, such as a serial line interface.

As referred to herein below, a virtualized UART interface refers to a UART-to-processor interface that is emulated by non-UART hardware or software. A computing arrangement may virtualize a UART interface via a component of the computing arrangement that operates outside the control of the operating system (OS).

Generally, any software or hardware component that can operate without an OS being loaded, or can continue to operate when an operating system crashes or reboots, may be considered to run independently of the OS. Such components may include the BIOS/firmware, which is capable of running before the OS is loaded. Other components that operate independently of the operating system include management service processors. Management service processors are devices (often expansion cards) that can be used to remotely manage a computer (e.g., via a network connection). Service processors can control computing hardware independently of the operating system, thus can enable remotely controlled service tasks, such as upgrading the BIOS, loading an OS, loading any other software, or rebooting a system.

Virtual UART interfaces that are provided by OS-independent components can be used for tasks such as kernel debugging, which should operate even if the OS has a kernel panic or reboots. The data processed by virtual UART interfaces can be transferred to external entities via another data interface, such as a network interface card (NIC).

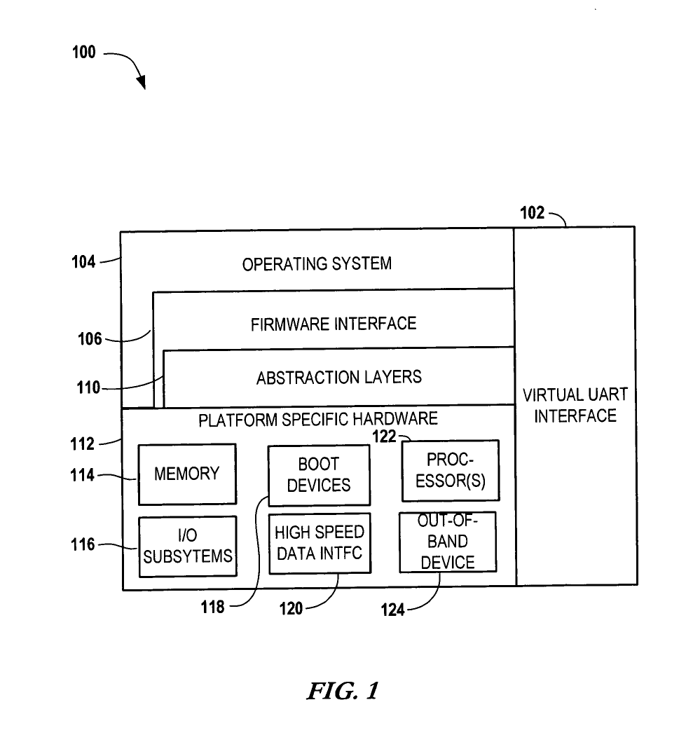

In reference now to FIG. 1, a computing architecture 100 is shown utilizing a virtual UART interface 102 according to embodiments of the present invention. The computing architecture 100 in this example includes an OS 104 that can be enabled to interact with the virtual UART interface 102 as if the virtual interface 102 were a hardware-based UART. The virtual UART interface 102 can be created by mapping a portion of memory controlled by an OS-independent component so that the portion of memory provides the structures and behaviors associated with a hardware-based UART.

As far as the OS 104 is concerned, the virtual UART interface 102 appears the same as a hardware-based UART, and can be used in exactly the same way. For example, where the OS 104 includes certain versions of the Windows™ OS, the virtual UART interface 102 may be used as a Windows debug port. A Windows debug port allows bi-directional data transfers between the Windows kernel/software and a data transmission device such as a terminal coupled to a UART.

The OS 104 interacts with a firmware interface 106 at boot and run times. System firmware is often included as a memory chip (e.g., EPROM) designed to operate with particular platform-specific hardware 110. The firmware interface 106 facilitate accessing various parts of the platform specific hardware 112 via firmware during boot and run-times of the OS 104. One or more abstraction layers 110 may also reside in firmware. The abstraction layers 110 encapsulate features that are unique to the platform specific hardware 112.

The firmware interface 106 may include a generic and extensible interface between the OS 104 to system hardware 112 such as provided by the Extensible Firmware Interface (EFI) specification. The EFI provides an OS loader, boot services, and run-time services. The EFI defines abstractions that allow a legacy OS loader (e.g., legacy BIOS code) to be reused without the end-user of the device having to worry about the underlying implementation. The EFI run-time services also provide an abstraction of underlying hardware resources for use by the OS 104 during run-time.

The abstraction layers 110 provide uniform access to processor and system functions that may vary between hardware implementations. In Itanium® architectures, the abstraction layer 110 includes a system abstraction layer (SAL). SAL includes functionality for initializing, testing, and configuring the platform specific hardware 112. The platform specific hardware 112 accessed by the SAL includes memory 114, I/O subsystems 116, boot devices 118, and other hardware such as a high-speed data interface 120. The OS 104 may be any OS now known or later developed that is capable of interacting with the firmware abstraction layer 110. In particular, the concepts described herein are applicable to Window™ OSes (e.g., Windows Server 2003) that are compatible with abstraction layers 110 such as SAL. In addition, the concepts described herein may be applicable to other abstraction layers 110, such as Advanced Configuration & Power Interface (ACPI) and Extensible Firmware Interface (EFI)

The abstraction layers 110 and firmware interface 106 provide a generic and extensible way for the OS 104 to interact with system hardware 112. Typically, the system manufacturer may modify the firmware components 106, 110 without affecting the OS 104 or the hardware 112. The ability to easily modify firmware allows for the implementation of the virtual UART interface 102 either partially or fully in firmware.

The virtual UART interface 102 may be implemented in any of the hardware and firmware layers of the illustrated architecture 100. Generally, the virtual UART interface 102 handles physical accesses by the OS 104 by behaving as a standard UART interface, such as a 16550-compatible UART. These accesses are translated by the virtual UART interface 102 to the interface of a different type of hardware. Hardware that may be configured to exchange data via the virtual UART interface 102 includes wired and wireless network interfaces, wired and wireless point-to-point interfaces, non-volatile solid state memory, disk drives, displays, USB, Firewire, Fibre Channel, etc. For example, the high-speed data interface 120 may include a network interface card such as an Ethernet card coupled to a TCP/IP network. Virtualization software can thus translate accesses at the virtualized UART interface 102 to socket-based accesses on the TCP-IP network.

The virtual UART interface 102 may also be configured to deal with data received from the OS purely in software. For example, the virtual UART interface 102 may be configured to simply discard the data where the end user has no desire to track the logged data. In such a case, the virtual UART interface 102 may act as a null device for purposes of satisfying minimum requirements. In another arrangement, the virtual UART interface 102 may contain a state machine that tracks certain kernel messages. For example, the virtual UART interface 102 may scan debug text for a kernel panic.

The virtual UART interface 102 may be implemented, either in whole or in part, in any out-of-band device 124 associated with the computing architecture 100. An out-of-band device 124 is generally a device that runs independently from the OS 104, although it may interface with the OS 104 during OS run time. Such a device 124 may be part of system firmware, hardware, add-in hardware, and/or a management service processor. Generally, the out-of-band device 124 operates outside of the control of the OS 104, and therefore can provide the virtual UART interface 102 independently of the OS 104.

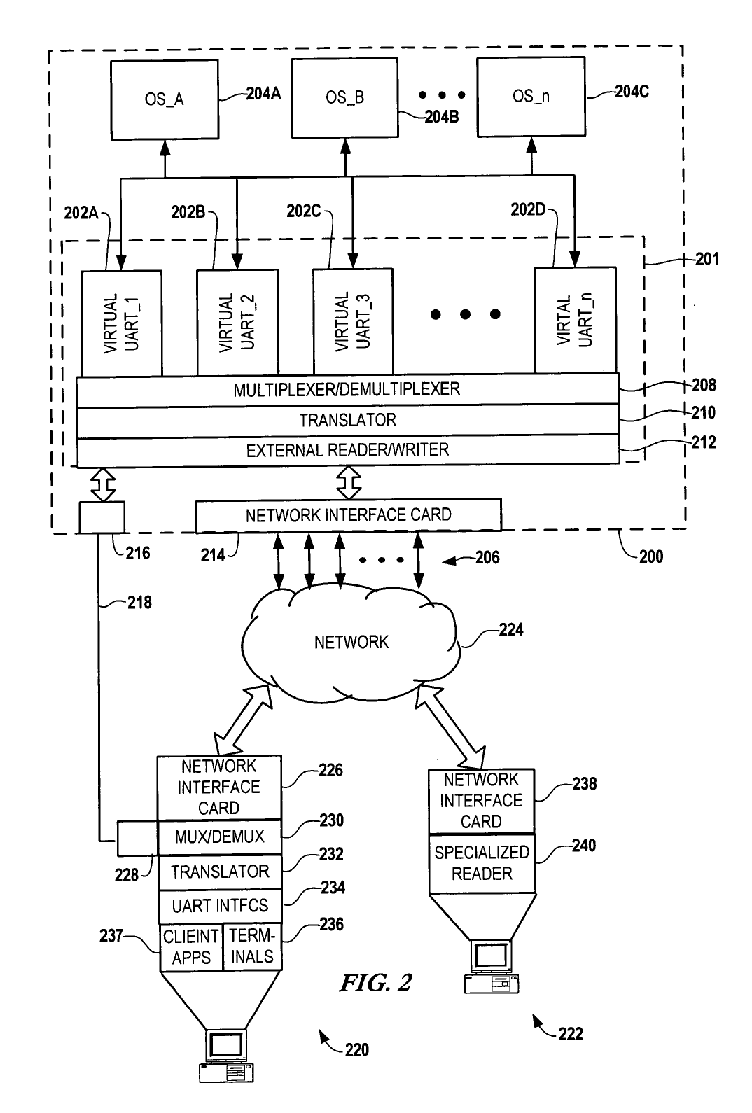

In FIG. 2, an example computing arrangement 200 includes a virtual UART 201 used to translate UART access to socket-based access according to embodiments of the present invention. The virtual UART 201 may include a plurality of discrete virtual UART interfaces 202A-D, similar to UART interface 102 in FIG. 1. The virtual UART 201 does not necessarily emulate all functions of a UART, but only those functions required to cause the UART interfaces 202A-D to respond to OSes 204A-C as if they were actual UART interfaces.

Each virtual UART interface 202A-D may be capable of being presented to and accessed by the OSes 204A-C as a discrete physical device. The OSes 204A-C may access multiple interfaces 202A-D at the same time. The OSes 204A-C may run one at a time (e.g., a multiple boot system) or run concurrently (e.g., a partitioned system). Where the OSes 204A-C are running simultaneously, the virtual UART interfaces 202A-D may be divided among the OSes 204A-C to prevent contention for resources.

The data processed by the plurality of UART interfaces 202A-D may be combined into a fewer number of outgoing data streams 206. This may occur, for example, where data from all of the UART interfaces 202A-D are combined into a single socket connection. In such a scenario, application-level data (e.g., headers) may be added to the data to identify which of the UART interfaces 202A-D a particular piece of data belongs. This added data may be used later to separate the data into individual UART streams.

In configurations where data from the UART interfaces 202A-D is combined into a fewer number of data streams 206, a multiplexer/demultiplexer 208 may be used. The multiplexer/demultiplexer 208 assembles multiple UART data streams into a fewer number of outgoing streams 206, and separates combined data coming from the streams for delivery to the appropriate UART interface 202A-D.

It will be appreciated that in arrangements where there is a one-to-one mapping of UART interface 202A-D to data streams 206, no multiplexer/demultiplexer 208 is required. This may occur, for example, where each UART interface 202A-D is mapped its own TCP/IP socket connection. Where each UART interface 202A-D has its own TCP/IP socket connection, the TCP/IP processing stack performs multiplexing/demultiplexing.

Other data manipulations may be required when transferring data between the virtual UART interface 202A-D and other interfaces. These manipulations may be performed by a translator component 210. The translator 210 may perform tasks such as stripping out control characters from outgoing data and inserting control characters in incoming data. Other translation tasks may involve swapping bit-order within bytes and byte order within words, adjusting package/frame sizes, managing serial data transfer states, etc.

In order to deal with external data transfer hardware, the virtual UART 201 may include an external reader/writer component 212. The external reader/writer component 212 may be configured to deal with multiple hardware interfaces for communicating data outside the computing arrangement 200. As previously discussed, one of these interfaces may include a network interface 214. The network interface 214 may include any known or future hardware used to share data with remote computers. Common network interfaces 214 include Ethernet, FDDI, ISDN, DSL, Token-Ring, modems, etc. Various communications protocols may also be associated with the network interface 214 such as TCP/IP, UDP/IP, ATM, X.25, VPN, PPP, etc. The network interfaces 214 may be coupled with the main processing board of the computing arrangement 200 (e.g., motherboard), or may be part of a device that runs independently of the operating systems 204A-C, such as a management service processor.

The reader/writer 212 may be configured to communicate over more than one external interface. This is represented by generic data interface 216 and connection path 218. The generic data interface 216 may include additional network interfaces, or other data transfer technologies such as point-to-point and broadcast. The generic data interface 216 may operate in parallel with the network interface 214 such that data from all UART interfaces 202A-D goes to both interfaces 214 and 216. Alternatively, a portion of the UART interfaces 202A-D may be assigned to the network interface 214, with the remainder assigned to the generic interface 216 (and/or additional interfaces).

The virtual UART 201 will typically include input and output buffers. This is because reads from the UART interfaces 202A-D will be filled from reads at the external reader/writer 212, which may occur at much higher data rates. Similarly, writes to the UART interfaces 202A-D may be conglomerated for more optimal transmission size. For example, data sent on a packet switched network 224 via the network card 214 may be conglomerated into a packet size appropriate for the network 224.

When the virtual UART 201 is configured to communicate over a network interface 214, the data may be sent/received to other data processing arrangements such as 220, 222, etc., via the network 224. The data processing arrangement 220 may include hardware and software components similar to that of the originating computing arrangement 200. Those components include a network interface 226, generic interface 228, a multiplexer/demultiplexer 230, a translator component 232, and virtual UART interfaces 234, which may provide functionality similar to the UART interface 102 of FIG. 1. Because the data processing arrangement 220 is using a virtualized UART interface 234, any software known in the art that can communicate via serial lines may be used to communicate with the computing arrangement 200. For example, basic terminal applications 236 (e.g., xterms) may be used to communicate over the virtual UART interfaces 234 without requiring any modification. Specialized client applications 237, such as debugger clients, may also access the virtual UART interfaces 234 without special modification.

The other data processing arrangement 222 also contains a network interface 238, but employs a specialized client application 240 that handles all of the functionality needed to exchange the data without requiring virtualized UARTs. The specialized reader application 240 may incorporate functions to store, view, and analyze all data received from the computing arrangement 200 and similar apparatus. The specialized reader application 240 may also have facilities for sending commands targeted for one or more virtual UART interfaces 202A-D of the computing arrangement 200.

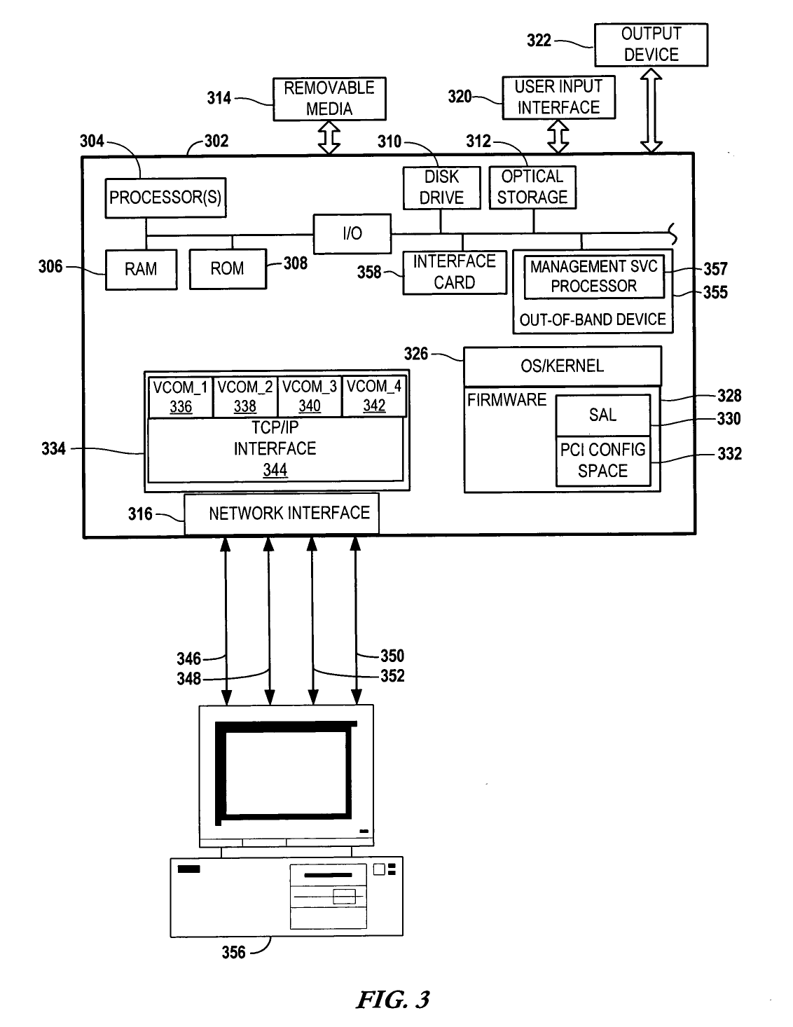

In reference now to FIG. 3, a computing arrangement 302 is shown providing a virtual UART interface coupled via TCP/IP according to embodiments of the present invention. The computing arrangement 302 includes one or more processors 304 coupled to various forms of memory. The processor(s) 304 are arranged to execute instructions stored on or provided by such memory. Memory accessible by the processor(s) may include random access memory (RAM) 306, read-only memory (ROM) 308, disk drives 310, optical storage 312 (e.g., CD-ROM, DVD), etc. The processor(s) 304 may also access data via memory available on removable media 314, such as floppy disks, Zip disks, flash memory, CD-ROM/R/RW, DVD, etc. The processor(s) 304 may also execute instructions received via a network interface 316.

The network interface 316 may be data coupled to any data transfer network such as a local area network (LAN), wide area network (WAN) or global area network (GAN) such as the Internet. The network interface 316 may be coupled with a main processing board of the computing arrangement 302 (e.g., motherboard), a management service processor 357 or other out-of-band device 355.

The computing arrangement 302 may include and/or be coupled to a user input interface 320 and an output device 322 (e.g., a monitor) for interacting with users. The data processing hardware 302 includes software that may be provided in the form of instructions executable by the processor(s) 304. Generally, the software includes an OS 326 for the control and management of hardware 302 and basic system operations, as well as running applications. The OS 326 may include any type of kernel (e.g., monolithic kernel, microkernel, exokernel, etc.) and user interface software such as a shell and/or graphical user interface (GUI).

The computing arrangement 302 includes firmware 328 used by the OS/kernel 326 for accessing hardware and processor functionality during boot time and run time. The firmware 328 may include a Basic Input-Output System (BIOS) for providing basic hardware access during system boot. The firmware 328 may include advanced features for providing hardware access, such as having an EFI interface. In particular, the firmware 328 may include a SAL 330 for abstracting various hardware interfaces such as a PCI configuration interface 332.

In the illustrated arrangement 302, a virtual UART component 334 is included. The virtual UART component 334 may have features similar to the virtual UART 201 in FIG. 2. The virtual UART component 334 provides four virtual UART interfaces 336, 338, 340, and 342. The use of four virtual UART interfaces in the illustrated component 334 is arbitrary; any number of virtual UART interfaces may be provided by the component 334, and the number and designation of interfaces may be determined statically or dynamically.

The four virtual UART interfaces 336, 338, 340, and 342 are directly mapped, via a network interface 344, to four TCP/IP sockets 346, 348, 350, and 352, respectively. In this example, there is a one-to-one mapping between the virtual UART interfaces 336, 338, 340, 342 and sockets 346, 348, 350, 352. A management terminal 356 is configured to connect to the TCP/IP sockets 346, 348, 350, and 352 to exchange data with the computing arrangement 302.

One use of the illustrated arrangement 302 is to provide the virtual UART interfaces 336, 338, 340, and 342 to each partition of a multi-partition system. The multi-partition system may include a single system that has multiple OS images running, and/or may include multiple computers running in a single complex/rack, such as a blade server system. The arrangement may be configured so that each partition is assigned a predetermined socket, defined by an IP address and TCP port. For example, partition 0 could be made available at port 2000, partition 1 at port 2001, partition 2 at port 2002, etc.

The virtual UART component 334 may be implemented in any combination of hardware, firmware, and software. For example, the virtual UART component may be implemented entirely in firmware using EFI and SAL. In such an implementation, the virtual UART interfaces 336, 338, 340, and 342 may be presented in PCI configuration space 332 as a well-known UART interface (e.g., 16550-compatible).

In other arrangements, the virtual UART component 334 may be implemented in hardware. The virtual UART component 334 may be hosted on a out-of-band device 355 that is outside the control of the operating system 326, such as a management service processor 357 or some other intermediary device. Typically, the management service processor 357 is an independently running device (e.g., on-board circuits, expansion slot card) that runs independently from the host OS and can be accessed independently of the host OS.

In another example, the virtual UART component 334 could be provided on a standard bus interface card 358 (e.g., PCI card) that presents itself as one or more UARTs and includes the network interface 316 and a physical network connector (e.g., Ethernet twisted pair). The functionality that provides translation of UART data to network data may be contained entirely on such a card 358, so that no specialized OS drivers or kernel software is required to communicate with the device 358.

It will be appreciated that the arrangement and composition of the hardware 302, firmware 328, virtual UART component 334, and operating system 326 may differ from that described in relation to FIG. 3. It will be apparent to those skilled in the art that the descriptions provided herein of the virtual UART component 334 and related software are independent of any particular configuration of the computing arrangement 302 or its operating environment.

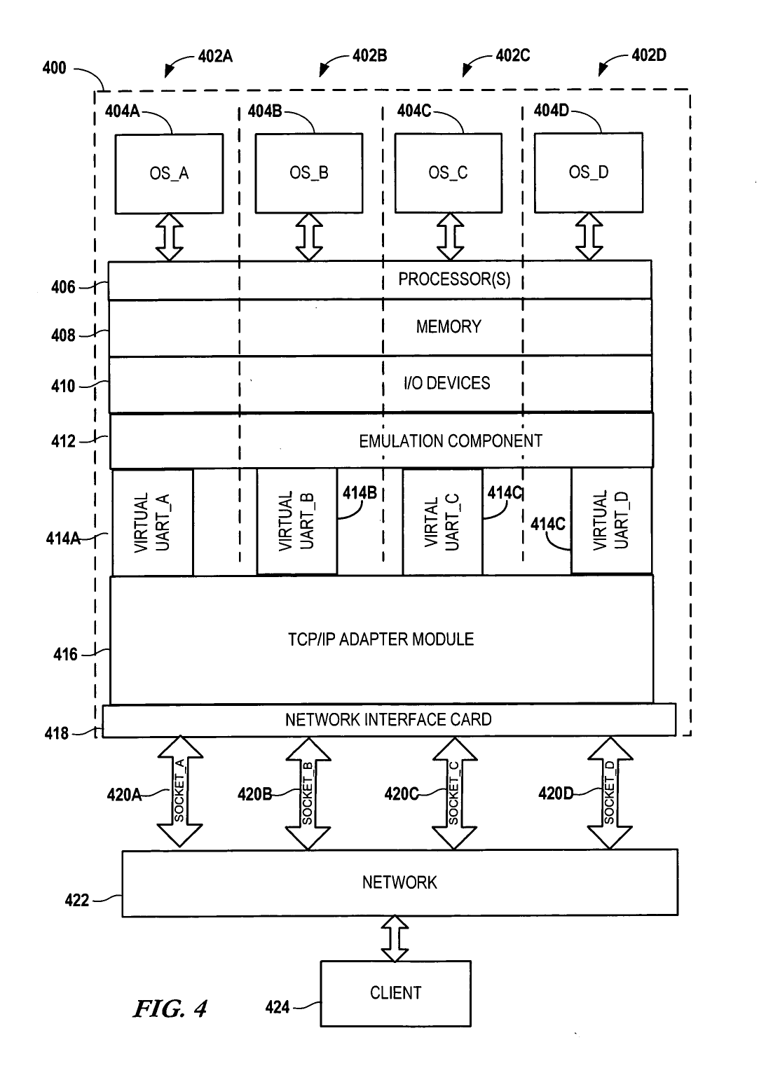

A particular example of an apparatus that may utilize virtual UARTs according to embodiments of the present invention is shown in FIG. 4 as the partitionable data processing arrangement 400. The example arrangement 400 includes four partitions 402A-D, although it will be appreciate that any number of partitions may be provided. Each partition 402A-D has an associated instance of an operating system 404A-D, respectively, running in that partition 402A-D.

Each partition 402A-D has a separately allocated portion of hardware resources. These resources may include one or more processors 406, memory 408, and I/O devices 410. The partitionable data processing arrangement 400 may include a computing arrangement that has multiple OS images running, and/or the arrangement 400 may include multiple computers running in a single complex/rack, such as a blade server system. The partitions 402A-D may be defined/created in an emulation component 412 which may include capabilities similar to the virtual UART 201 in FIG. 2. The emulation component 412 may include any combination of firmware or a dedicated hardware (e.g., management service processor). In such an arrangement the emulation component 412 distributes the hardware resources between the partitions 402A-D.

The emulation component 412 provides each partition 402A-D and its associated operating system 404A-D with a virtual UART interfaces 414A-D. The virtual UART interfaces 414A-D may be used, among other things, to send/receive bi-directional data from the operating systems 404A-D, respectively. The virtual UART interfaces 414A-D may be mapped to an address space of the emulation component 412. A TCP/IP adapter module 416 is arranged to accept bi-directional data from the virtual UART interfaces 414A-D and communicate that data via a network interface card 418. The TCP/IP adapter module 416 may be implemented in the emulation component 412.

The TCP/IP adapter module 416 is configured to associate each operating system 404A-D with TCP/IP sockets 420A-D, respectively. These sockets 420A-D may be used to exchange bi-directional data between the operating systems 404A-D via a network 422 to a client 424 configured to access bi-directional data associated with each of the partitions 402A-D. Generally, the client may allow the bi-directional data from each partition 402A-D and operating system 404A-D to be accessed separately. The client 424 may be a reader or an application such as a kernel debugger that sends/receives data, sets breakpoints, etc.

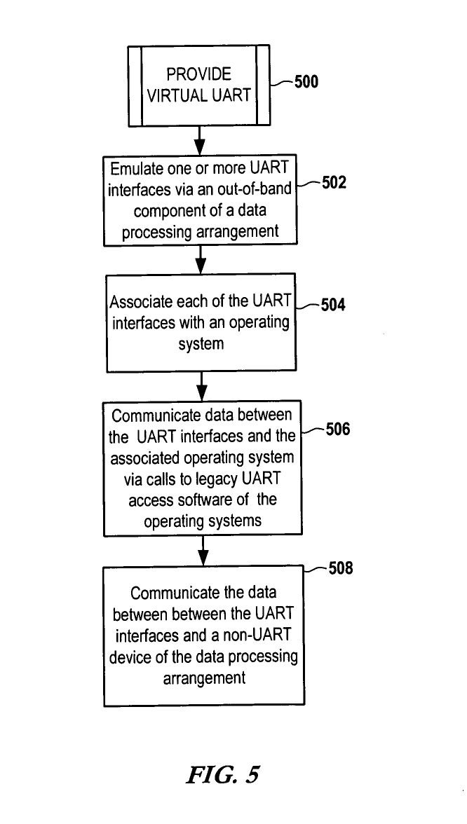

In reference now to FIG. 5, a procedure 500 is illustrated for providing a virtual UART interface according to embodiments of the present invention. One or more UART interfaces are provided to emulate a UART (502) via an out-of-band component of a data processing arrangement. This out-of-band component may include, for example, a portion of firmware memory space that is configured as a UART interface. Alternatively, the component may include a management service processor that virtualizes a UART interface. The virtual UART interface may be implemented in a legacy UART address space, or it may be a standard UART interface implemented in a new address space. The OS could be configured to support the standard interface in a typical address space, and the virtual interface implemented in that address space. This implementation may be followed, for example, in a firmware-only solution where the eight-byte UART address space is defined in ACPI or in firmware-emulated PCI configuration space.

Each of the UART interfaces is associated (504) with an OS. In a partitionable system, there may be a one-to-one mapping of virtual UART interfaces to OSes. Other mappings of virtual UART interfaces to OSes are also possible. This mapping may be enabled, for example, by presenting firmware accessors to the virtual UARTs interfaces in response to a query from each of one or more OSes. The OS may access the memory range for communicating (506) the data at each UART interface via calls to legacy software of the associated OS. This legacy software may be, for example, device drivers and/or kernel software of the associated OSes. In response to data transfers at the virtual UARTs interface, the data is communicated (508) between the UART interfaces and a non-UART device of the data processing arrangement.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention may be implemented in any combination of hardware and software.

It will be appreciated that processor-based instructions for implementing embodiments of the invention are capable of being distributed in the form of a computer readable medium of instructions and a variety of other forms. The description herein of such processor-based instructions applies equally regardless of the particular type of signal bearing media actually used to carry out the distribution. Examples of computer readable media include media such as EPROM, ROM, tape, paper, floppy disc, hard disk drive, RAM, and CD-ROMs and transmission-type media such as digital and analog communications links.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

What is claimed is:

1. A processor-based method of providing external data communications for one or more operating systems of a data processing arrangement, comprising:
virtualizing one or more Universal Asynchronous Receiver-Transmitter (UART) interfaces via a component of the data processing arrangement that operates outside the control of the operating systems;
associating each of the UART interfaces with an operating system selected from the one or more operating systems;
communicating data between the UART interfaces and the associated operating systems via calls to standardized hardware access software of the associated operating systems; and
communicating the data between the UART interfaces and a non-UART device of the data processing arrangement.

2. The method of claim 1, wherein virtualizing the one or more UART interfaces comprises virtualizing the one or more UART interfaces via a management service processor of the data processing arrangement.

3. The method of claim 2, wherein communicating the data between the UART interfaces and the non-UART device comprises communicating the data between the UART interfaces and a network interface of the management service processor.

4. The method of claim 3, further comprising mapping each of the UART interfaces to a different TCP/IP socket of the network interface.

5. The method of claim 1, wherein virtualizing the one or more UART interfaces comprises virtualizing the one or more UART interfaces via firmware of the data processing arrangement.

6. The method of claim 1, wherein communicating the data between the UART interfaces and a non-UART device the non-UART device comprises communicating the data between the UART interfaces and a network interface.

7. The method of claim 6, further comprising mapping each of the UART interfaces to a different TCP/IP socket of the network interface.

8. The method of claim 1, wherein communicating the data between the UART interfaces and a non-UART device of the data processing arrangement comprises communicating the data between the UART interfaces and an external data bus interface.

9. The method of claim 1, wherein communicating data between the UART interfaces and the associated operating systems comprises communicating operating system debug data between the UART interfaces and the associated operating systems.

10. The method of claim 9, wherein communicating operating system debug data between the UART interfaces and the associated operating systems comprises communicating Windows debug port data between the UART interfaces and the associated operating systems.

11. The method of claim 1, further comprising accessing the data via a client device that is coupled to the non-UART interface of the data processing arrangement.

12. The method of claim 1, wherein communicating the data via calls to standardized hardware access software of the associated operating systems comprises communicating the data via calls to standardized device drivers of the associated operating systems.

13. The method of claim 1, wherein communicating the data via calls to standardized hardware access software of the associated operating systems comprises communicating the data via calls to standardized kernel software of the associated operating systems.

14. The method of claim 1, further comprising multiplexing the data communicated between the UART interfaces and a non-UART device into a single data stream associated with the non-UART device.

15. An apparatus, comprising:
one or more processors arranged to run one or more operating systems;
a non-UART data exchange device;
an out-of band component coupled to the processor that operates independently of the operating system;
an emulation component that provides hardware access to the operating systems, the component causing the processors to,
access one or more virtual UART interfaces at an address space defined by the out-of-band component;
associate each of the virtual UART interfaces with an operating system selected from the one or more operating systems;
communicate data between the virtual UART interfaces and the associated operating systems via standardized software components of the associated operating systems; and
communicate the data between the virtual UART interfaces and the non-UART data exchange device in response to the data communicated between the virtual UART interfaces and the associated operating systems.

16. The apparatus of claim 15, wherein the out-of-band component comprises a management service processor.

17. The apparatus of claim 16, wherein the management service processor comprises a network interface, and the non-UART device comprises the network interface of the management server processor.

18. The apparatus of claim 17, wherein the one or more virtual UART interfaces are each mapped to a different TCP/IP socket of the network interface.

19. The apparatus of claim 15, wherein the non-UART device comprises a network interface.

20. The apparatus of claim 19, wherein the one or more virtual UART interfaces are each mapped to a different TCP/IP socket of the network interface.

21. The apparatus of claim 15, wherein the non-UART device comprises an external data bus interface.

22. The apparatus of claim 15, wherein the out-of-band component comprises firmware.

23. The apparatus of claim 15, wherein the one or more operating systems each run in a separate partition of the apparatus.

24. The apparatus of claim 15, wherein the standardized software components of the operating systems comprise device drivers of the operating systems.

25. The apparatus of claim 15, wherein the standardized software components of the operating systems comprise kernel software of the operating systems.

26. A processor-readable medium, comprising:
a program storage device configured with instructions for causing a processor of a data processing arrangement running one or more operating systems to perform the operations of,
virtualizing one or more Universal Asynchronous Receiver-Transmitter (UART) interfaces via a component of the data processing arrangement that operates independently of the operating systems;
associating each of the UART interfaces with an operating system selected from the one or more operating systems;
communicating data between the UART interfaces and the associated operating systems via calls to standardized software of the associated operating systems; and
communicating the data between the UART interfaces and a non-UART device of the data processing arrangement.

27. The processor-readable medium of claim 26, wherein the non-UART device comprises a network interface.

28. The processor-readable medium of claim 26, wherein the component of the data processing arrangement that operates independently of the operating systems comprises a management service processor of the data processing arrangement.

29. The processor-readable medium of claim 26, wherein the component of the data processing arrangement that operates independently of the operating systems comprises firmware of the data processing arrangement.

30. A data processing arrangement comprising:
means for presenting one or more virtual Universal Asynchronous Receiver-Transmitter (UART) interfaces to one or more operating systems of the data processing arrangement;
means for associating each of the UART interfaces with an operating system selected from the one or more operating systems;
means for communicating data between the UART interfaces and the associated operating systems via calls to standardized software of the associated operating systems; and
means for communicating the data between the UART interfaces and a non-UART device of the data processing arrangement.
